(19) United States
(12) Patent Application Publication
(10) Pub. No.: US 2005/0063899 A1
(43) Pub. Date: Mar. 24, 2005

(54) Two-stage auto thermal reforming process and system

(75) Inventor: James F. Leahy, Tulsa, OK (US)

Correspondence Address: JENKENS & GILCHRIST, 1401 MCKINNEY, SUITE 2600, HOUSTON, TX, 77010, US

(73) Assignee: Syntroleum Corporation, Tulsa, OK (US)

(21) Appl. No.: 10/924,174

(22) Filed: Aug. 23, 2004

Related U.S. Application Data
(60) Provisional application No. 60/496,774, filed on Aug. 21, 2003.

(51) Int. Cl. C01B 3/26

(52) U.S. Cl. 423/651

(57) ABSTRACT

A process for converting a light hydrocarbon stream into a synthesis gas in a two stage reactor vessel having two active catalyst zones is provided.

### CROSS REFERENCE TO RELATED APPLICATIONS

This application claims priority to U.S. Provisional application Ser. No. 60/496,774 filed on Aug. 21, 2003.

### FEDERALLY SPONSORED RESEARCH

Not applicable.

### REFERENCE TO MICROFICHE APPENDIX

Not applicable.

### FIELD OF THE INVENTION

This invention relates to the production of synthesis gas using an oxygen-containing gas as the oxidant and light hydrocarbons as the carbon source.

### BACKGROUND OF THE INVENTION

Light hydrocarbons are converted to synthesis gas (“syngas”) by a variety of methods. As used herein, the term “light hydrocarbons” means one or more hydrocarbon gasses composed predominantly of hydrocarbons having a carbon number of 4 or less. Light hydrocarbons may include by way of example but not limitation, natural gas or gasified coal. Syngas is comprised substantially of carbon monoxide and molecular hydrogen. Traditional methods of producing syngas include steam reforming wherein one or more light hydrocarbons are reacted with steam over a reforming catalyst to form carbon monoxide and hydrogen. When water (steam) is used to oxidize (reform) the light hydrocarbon feed, it contributes both oxygen and hydrogen to the product mix. A reforming catalyst containing nickel is often utilized. The contribution of hydrogen and the subsequent shift conversion of product CO by water produce a synthesis gas having relatively high ratios of hydrogen to CO. Thus steam reforming of light hydrocarbons is favored for the production of hydrogen. Reforming of light hydrocarbons with water is endothermic. Heat must be added to sustain reaction temperature. Reactor designs feature heat transfer tubing containing reforming catalyst and operating at high temperature.

Reforming of light hydrocarbons with carbon dioxide is a second method generally done only in conjunction with recycle of byproduct CO₂. Carbon dioxide contributes both carbon and oxygen (but not hydrogen) to the product mix. Consequently, CO₂ reforming is useful in recovering carbon and oxygen, which would otherwise represent a loss of raw material, and in the production of carbon monoxide-rich product gas. When performed in conjunction with steam reforming, CO₂ reforming has the effect of reducing the H₂/CO ratio of the product synthesis gas.

A third method to produce syngas is partial oxidation, wherein one or more light hydrocarbons are combusted sub-stoichiometrically to produce synthesis gas. Partial oxidation is the catalytic or non-catalytic, sub-stoichiometric combustion of light hydrocarbons to produce the synthesis gas. The partial oxidation reaction is typically carried out using high-purity oxygen. Partial oxidation of light hydrocarbons by molecular oxygen contributes oxygen (but not hydrogen or carbon) to the product mix. It yields a synthesis gas having a hydrogen to CO ratio lower than that of steam reforming and higher than that of CO₂ reforming. It is ideally suited to the production of synthesis gas for use in Fischer Tropsch and methanol syntheses.

The partial oxidation reaction is exothermic. The exothermic nature of the reaction leads to the concept of “auto-thermal” reforming. In auto-thermal reforming, partial oxidation of the feedstock provides the heat needed to raise the temperature of the feeds. Oxidation products that would otherwise be lost in flue gas become part of the product stream. The synergy of feed and fuel is further enhanced by the desire to achieve high temperatures. High temperatures favor the conversion of light hydrocarbons to product. Auto-thermal heating of the reactants and products allows high temperatures to be achieved while avoiding or greatly reducing the cost of heat transfer equipment.

Partial oxidation and steam reforming may be combined in a process known as autothermal reforming (“ATR”). Autothermal reforming is thus a combination of partial oxidation and steam reforming wherein the exothermic heat of partial oxidation supplies the necessary heat for the endothermic steam reforming reaction. The ATR process may be carried out in a relatively inexpensive refractory lined carbon steel vessel whereby a cost advantage is achieved. Further, the need to provide expensive and costly pure oxygen as combustion fuel may be avoided as air or enriched air may be used as the source of oxygen.

In conventional autothermal reactors, a burner is frequently used to combust the light hydrocarbon stream with an amount of an oxidant, which may be air or oxygen-enriched air or pure oxygen. The combustion product is then passed through a reforming catalyst to convert the oxidation product into a synthesis gas at equilibrium conditions at the temperature and pressure in the autothermal reactor. Unless a substantial amount of steam is injected with the mixture of light hydrocarbons and oxidant, conventional ATR reactors form soot. Soot represents wasted carbon and can constitute an undesirable plugging material in the catalyst bed. Various approaches have been tried in an effort to reduce or eliminate soot formation in such reactor vessels.

The ATR process typically results in a lower hydrogen to carbon monoxide ratio in the synthesis gas than does steam reforming alone. That is, the steam reforming reaction with methane results in a ratio of about 3:1 or higher while the partial oxidation of methane results in a ratio of about 2:1. A ratio of about 2:1 is frequently desired because a good ratio for the Fischer-Tropsch (“FT”) hydrocarbon synthesis reaction carried out at low or medium pressure (i.e., in the range of about atmospheric to 500 psig) over a cobalt catalyst is about 2:1. When the feed to the ATR process is a mixture of light shorter-chain hydrocarbons, such as a natural gas stream, some form of additional control is usually desired to maintain the ratio of hydrogen to carbon monoxide in the synthesis gas at the optimum ratio of about 2:1 (for cobalt based FT catalysts). For this reason, steam and/or CO₂ may be added to the synthesis gas reactor to adjust the H₂:CO ratio to the desired value with the goal of optimizing process economics.

Some prior art methods have employed a two-zone ATR reactor in which homogenous combustion occurs in the first zone and reforming occurs within the second zone. However, the two-zone ATR provides several significant technical drawbacks with respect to operability and cost relative to the present invention. For example, U.S. Pat. No. 5,112,527 (the “527 patent) teaches using a two-zone reactor wherein all oxygen added to the system is added before the first stage. Unreacted hydrocarbons are reformed with water over a catalyst in the second stage. One objective of the '527 patent is to maintain a temperature low enough in the first reactor zone to avoid decomposition of the light hydrocarbons. This is accomplished by restricting the amount of oxygen added to the system. The reaction is completed in the second stage by reforming with steam. The steam reforming reactions produce a higher H₂:CO ratio. For example, in the first example of table 2 of the '527 patent, the resulting syngas has a H_{2:}CO ratio of 2.33:1. For a Fischer-Tropsch reaction with a cobalt catalyst, the desirable ratio is typically the consumption ratio, which is around 2:1. Therefore, with the two stage process of the '527 patent as pressure of the ATR reactor is increased, it is likely that the amount of steam addition will go up making the H₂:CO ratio higher and less desirable.

The process of the present invention efficiently converts the hydrocarbon feed into synthesis gas of the desired ratio of approximately 2:1. The present invention mixes the reactants in a safe and efficient manner. In one embodiment of the present invention, air is used while in another embodiment of the invention, pure oxygen is used. If all of the air or enriched air were added to the hydrocarbon feed at the front of the reactor, it would result in a potentially flammable mixture. Potential hazards of flammability can be avoided by conducting the mixing at relatively low residence time. Furthermore, shut down or upset conditions make it desirable to avoid a flammable mixture feeding the first stage reactor. Additionally, operating issues, i.e. production of soot, may occur when operating near the flammability region. This issue becomes worse at elevated pressure. These issues may be improved by adding steam but then the H₂:CO ratio increases.

Stage-wise addition of high purity oxygen to light hydrocarbons in numerous small steps with removal of heat between each step allows oxidation of the feed to cumulatively proceed to any desired level. By maintaining moderate temperatures and low levels of oxygen in each of the staged feed mixtures it is possible to avoid pre-ignition. This variation is impaired by the high cost of numerous small reaction steps and by the relatively low temperature and equilibrium driving forces of the products exiting the final stage.

Embodiments of the invention are designed to split the addition of air or enriched air into two stages. The mixing device and reactor operate safely outside the flammability window and steam addition can be set to produce the desirable H₂:CO ratio.

### SUMMARY OF THE INVENTION

In the invention, a process for converting methane or light hydrocarbons to synthesis gas in a two-stage reactor vessel having two active catalyst zones is provided. The process comprises mixing methane, steam, and an oxygen-containing gas (air or enriched air) to form a mixed gas in a mixing zone. The mixing zone is separated from the first active catalyst zone or first reaction section. The mixed gas may be reacted flamelessly in the first catalyst zone. The reaction in the first reaction section will proceed until all of the oxygen has been consumed producing CO and H₂ and unreacted hydrocarbons. The O₂:C feed ratio into the first reaction section is specifically limited to consume all of the oxygen but avoid soot production. The reactants are allowed to reach equilibrium over a bed of synthesis gas catalyst, such as an Nickel on Alumina catalyst.

Additional air or enriched air is added to the product of the first reaction section resulting in a flame reacting with gases which were produced in the first reaction section. The resultant gas mixture is allowed to reach equilibrium over a second bed of Nickel on Alumina catalyst in a second reaction section. One result of the two-stage reactor system of the invention is production of CO and hydrogen safely and efficiently without the formation of soot and with an H₂:CO ratio of approximately 2:1. In alternative embodiments, the H₂:CO ratio is altered slightly by the addition of steam and/or CO₂ to the feed hydrocarbon.

### BRIEF DESCRIPTION OF THE DRAWINGS

FIG. 1 is a Block Flow Diagram showing the sequence of steps as outlined in the description.

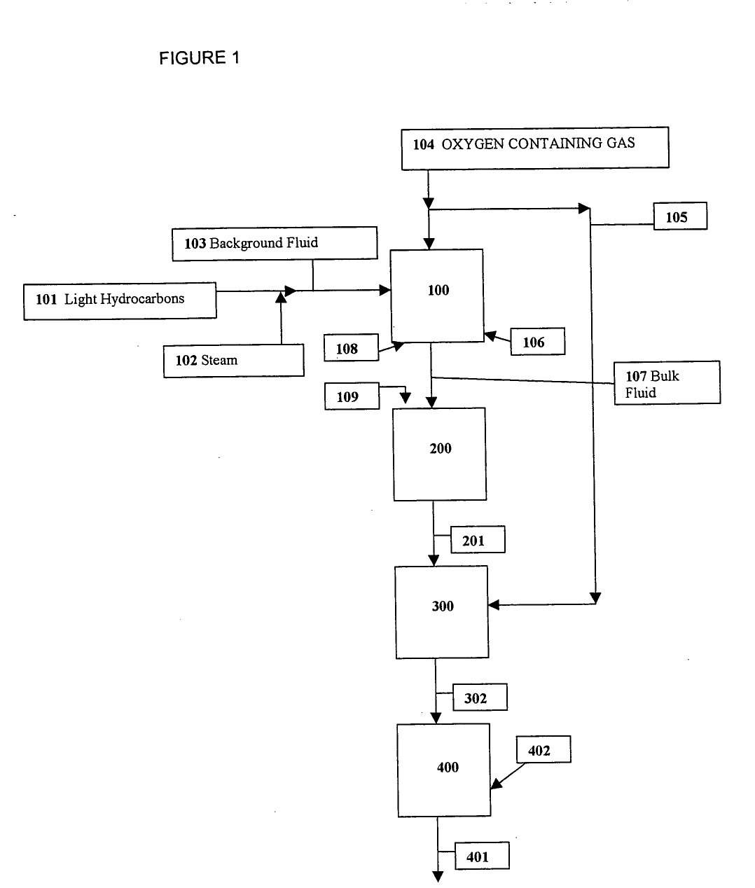

### DESCRIPTION OF EMBODIMENTS OF THE INVENTION

Embodiments of the process of the invention achieve catalytic partial oxidation of light hydrocarbon feed under conditions that avoid the need for ultra-rapid mixing and/or the need for addition of excessive quantities of diluents such as steam.

In some embodiments of the invention, an oxidizing gas is first mixed with a light hydrocarbon feed stream wherein the oxidizing gas is present in an amount less than the optimum for production of synthesis gas having a H₂ to CO ratio of about 2. The oxidizing gas and light hydrocarbon feed stream mixture is passed over a bed of suitable catalyst so as to effect partial oxidation and steam reforming. The products of the partial oxidation reaction are further subjected to non-catalytic partial oxidation by addition of a second oxidizing gas, in an amount needed to ultimately produce synthesis gas having a H₂ to CO ratio of about 2. The products of this second oxidation step are exposed to a reforming catalyst so as to effect reforming and shift conversion reactions.

Some embodiments of the system of the invention include a first mixing section 100, a first reaction section 200, a second mixing section 300, and a second reaction section 400. In some embodiments, these sections are encompassed by a single reactor. In alternate embodiments, these sections are encompassed by multiple reactors. The reactors are readily available from a number of manufacturers, including for example, Cust-O-Fab of Tulsa, Okla.

In order to maximize the yield of useful products in the reaction sections 200 and 400, it is desirable to heat the feeds prior to introduction into the mixing section 100, such heating being to about the highest practical temperature of about 950° F. In addition, to minimize or eliminate the need for recycle of undesirable byproducts, the relative proportions of light hydrocarbon, steam, and oxidizing gas feeds should be controlled to values disadvantageous to the reliable operation (i.e. soot formation) of the mixing and reaction devices. For example, in one embodiment of the invention, it is desired to produce hydrogen and carbon monoxide in a ratio of about two molecules of H₂ per one molecule of CO. It is further desired to minimize the amount of unreacted light hydrocarbon in the effluent from the second reaction section. It is further desired to operate the system at a pressure sufficiently high as to not impose an economic penalty on the recovery of products. These conditions generally promote non-catalytic oxidation and its undesirable localized heat release and decomposition of the light hydrocarbon feed. What is desired is partial oxidation of the light hydrocarbon feed at the active metal surface of the catalyst leading to limited localized heat release and limited formation of decomposition products.

Light hydrocarbon gas stream 101 previously mixed with steam 102 and heated to a feed temperature between about 750° F. and about 950° F., preferably between about 850° F. and about 950° F., and most preferably about 950° F., forms a background fluid 103. Light hydrocarbon gas stream 101 comprises methane and generally not more than about 6 vol % total heavier hydrocarbons (i.e., ethane, propane, etc.). The total content of methane plus heavier hydrocarbons is referred to as the hydrocarbon portion of the light hydrocarbon gas stream 101. Light hydrocarbon gas stream 101 may further include carbon dioxide and inert gases but the combined carbon dioxide and inert gas content should preferably not exceed 75 vol %, more preferably should not exceed 50 vol %, and most preferably should not exceed 25 vol % of the light hydrocarbon gas stream 101. The amount of steam 102 mixed with the light hydrocarbon gas stream 101 may range from about 2 to about 160 vol %, more preferably from about 22 to about 36 vol %, of the hydrocarbon portion of the light hydrocarbon gas stream 101.

A first oxygen-containing gas 104 (also referred to herein as a first oxidizing gas) is heated to temperatures in the range of from about 400 to about 1050° F., more preferably from about 750 to about 950° F., and most preferably to about 950° F. The heated first oxygen-containing gas is mixed with the background fluid 103 in the first mixing section 100. In a preferred embodiment, the first oxygen-containing gas 104 is sparged into the first mixing section 100 in small increments. The pressure of the first mixing section 100 may be maintained between about 0 and about 300 psig, more preferably from about 100 to about 200 psig. The quantity of oxygen in the first oxidizing gas 104 may range from between about 30% and about 68%, more preferably between about 45% and about 55%, by volume of the hydrocarbon portion of the light hydrocarbon gas stream 101. The velocity of the mixture is maintained at a high value, at least about 100 ft/sec, and preferably no less than 200 ft/sec, to assure prompt delivery of the mixture to the surface of the catalyst which is present in the first reaction section 200. The duration of time from the final mixing of the first oxidizing gas 104 and the light hydrocarbon gas stream 101 to the contacting of the catalyst is less than 7 seconds, more preferably less than 1000 milliseconds. The quantity of oxidizing gas 104 sparged into the background fluid 103 is less than the amount required to achieve the final desired extent of conversion of light hydrocarbon feed into synthesis gas. That is, complete conversion of the light hydrocarbons into synthesis gas is not achieved in reaction section 200. This is done to minimize the tendency of the background fluid to undergo non-catalytic partial oxidation. To achieve the desired final extent of oxidation, a portion 105 of the oxidizing gas 104 is bypassed to the second mixing section 300. The relative amount of oxidizing gas bypassed around the first mixing section 100 and first reaction section 200 depends on the relative proportions of other gases present in the light hydrocarbon and oxidizing gas streams and on the temperature and pressure of the background fluid 103. Generally, between about 15% and 40% of the oxidizing gas is bypassed. The higher the temperature and pressure the greater amount bypassed and the higher concentration of ethane, propane, butane the higher amount bypassed.

In a preferred embodiment, the oxidizing gas 104 is air. The quantity of oxygen is from about 5% to about 25% of the total amount of oxygen fed to the process, more preferably about 10% to about 21%. The temperature of the air is at least 400° F., more preferably about 750° F. to about 900° F. In alternate embodiments, the oxidizing gas 104 is oxygen or oxygen-enriched air.

The mixing device can consist of a tube with perforated lances, quills, rings, or “finger” spargers. It is possible to combine mixing devices as in a battery of parallel tubes. The relatively low level of oxidant fed to the first step greatly reduces the tendency of the feed mixture to auto-ignite. Allowable mixing durations, which are orders of magnitude longer for mixtures of air and light hydrocarbons than they are for mixtures of oxygen and light hydrocarbons, can be further extended by limiting the air feed to sub-optimal values. Whereas it is typical for the ratio of oxygen in the oxidant gas to carbon in the light hydrocarbon gas to be form about 0.55 to about 0.68, by reducing the ratio to 0.45 to 0.55, auto-ignition lag times increase several-fold. The additional available mixing time allows the use of rather “low-tech” mixing devices. Also, the need to studiously avoid stagnant areas is greatly relaxed. For example, in U.S. Pat. No. 6,447,745, a mixing device utilizing oxygen requires a mixing time of less than ten milliseconds. Ultra-rapid mixing devices impact the successful mixing of oxygen gas with light hydrocarbons while avoiding combustion. Such devices have yet to be commercialized at the Fischer-Tropsch scale. The need for ultra-rapid mixing is greatly alleviated by the use of air as the oxidizing gas in place of relatively pure oxygen. As described in U.S. Pat. No. 6,344,491, when air is used as the oxidizing gas, it is possible to increase the auto-ignition lag time to several hundred milliseconds. The embodiments of the invention described herein allow further reduction in the oxygen content of the mixed feed thus extending the auto-ignition lag time to several thousand milliseconds. This greatly simplifies the process and devices for mixing the feeds. The balance of oxygen needed to complete the partial oxidation reaction must be added in a separate step.

Any of a variety of known mixing devices and methods may be utilized to achieve the mixing of the feed gasses in both the first mixing section 100 and the second mixing section 300. By way of example but not limitation, such mixing devices and methods may include those disclosed in U.S. Pat. Nos. 3,871,838; 4,477,262; 4,166,834; 4,865,820; and 4,136,015. The disclosures of each of these patents is incorporated herein by reference and are further attached hereto as Appendix A and made a part hereof.

In the first mixing section 100, in each of the numerous mixing orifices, two streams, i.e. the light hydrocarbons and steam mixture (the background fluid) 103, which is above the traditionally defined upper flammable limit, and the oxidizing gas 104, which is below the lower flammable limit, are mixed. The gases 103 and 104 form numerous “envelopes” in which the background fluid and the oxidizing gas are in proportions at or near their stoichiometric ratios. The design of the devices utilized in the mixing section 100 minimizes the size of the individual envelopes and avoids the overlapping of such envelopes as necessary steps in the dilution of oxygen into the light hydrocarbons and steam mixture, i.e, the background fluid. The resulting bulk fluid mixture 107, which contains light hydrocarbons 101, steam 102, and oxidizing gas 104, is flammable in the traditional sense. However, the bulk fluid 107 is transported to the catalyst within the first reaction section 200 at a high rate, at least about 100 ft/sec, and preferably no less than 200 ft/sec, to minimize the extent of non-catalytic side reactions. In addition, the bulk mixture 107 is transported in such a manner as to avoid formation of stagnant zones where self-heating could potentially result in a temperature rise and intolerably high non-catalytic partial oxidation.

The effluent from the first mixing section, the bulk fluid, 107 is passed over the fixed catalyst of the first reaction section 200. Whereas the velocity is maintained at a high value in the first mixing device 100, it is necessary to decelerate the bulk fluid feed 107 into the first reaction section 200. This is done by a gradual expansion of the cross sectional area of an inlet, or transitional, portion 109 of a first autothermal reforming reactor (ATRR) utilized in the first reaction section 200. Alternatively, the velocity of the bulk fluid 107 may be decreased by a gradual expansion of a transitional conduit between the first mixing section 100 and the first reaction section 200. The transitional conduit or expansion portion of the first autothermal reforming reactor, must be sufficiently gradual to avoid the formation of back-mixed eddies, but short enough to avoid undue delay in the onset of partial oxidation reactions.

Upon exposure to an active metal catalyst present in the first reaction section 200, oxygen in the bulk feed mixture 107 is rapidly consumed essentially to completion. The heat release associated with the partial oxidation reaction is mitigated in part by the simultaneous reforming of light hydrocarbon gas by steam added to the feed for the purpose of adjustment of the ratio of H₂ to CO in the second reaction section 400. The catalytic partial oxidation and reforming step is conducted downward over a bed of catalyst particles. As the gas mixture contacts the catalyst, both catalytic partial oxidation and steam reforming reactions occur simultaneously. The heat of reaction raises the temperature of the products, promoting conversion to desired products and assuring high reaction rates. Since the auto thermal reforming process is adiabatic, there is no need to heat the reactants as the reaction proceeds. Catalyst can be loaded in a single packed bed rather than into multiple reforming tubes as in conventional steam reforming processes. The catalyst particles preferably consist of nickel and promoter metals on alumina. Acceptable carbon efficiencies can be achieved at relatively mild feed temperatures on a once-through basis.

The catalyst of the first reaction section 200 can be any of the non-noble metal supported steam reforming catalysts readily available from numerous suppliers. Nickel on alumina is an example of such a catalyst. Suitable catalysts are well known in the art and are available from several sources, including Johnson Matthey. The catalyst is covered by a layer of support. The support prevents the back-radiation of heat from the support zone into the incoming gas mixture. The quantity of catalyst is approximately one five thousandth to about one fifteen thousandth of the quantity, measured in standard cubic feet per hour, of hydrogen produced in the first reaction section 200. More preferably, this quantity is about one six thousandth to about one nine thousandth. The quantity of support is at least the minimum required to prevent excessive radiant heat transfer into the bulk stream. That is, support is loaded to a depth in which the top layer of support remains at the same temperature as the incoming gas. More preferably, the quantity of support is the amount sufficient to cover the bed of catalyst to a depth of about 6 inches to about 12 inches.

The hot, partially-oxidized gaseous product 201 from the first reaction section 200 is transferred to the second mixing section 300. The bypassed oxidizing gas 105 is sparged into the partially-oxidized gaseous product 201 from the first reaction section 200. In the second mixing section 300, unlike the first reaction section 200, non-catalytic partial oxidation begins to occur immediately at the point of mixing 301. A flame forms at the orifices of each of the mixing or sparging devices. High local temperatures are created at the flames. However, the heat is rapidly dissipated into the bulk product 302, minimizing the formation of unsaturated free radicals of the light hydrocarbons and the undesirable products of those free radicals. The extent of free radical formation is dependent on the amount of unreacted feed “slippage” from the first reaction section 200, the temperature of the bulk product fluid 302, the system total pressure, and the presence of hydrogen, steam, and diluents in the bulk product fluid 302. The combustion (second partial oxidation) step is carried out by the addition of air. The amount of air added is that required to achieve the desired final product mix. The conditions of the second partial oxidation step favor immediate ignition of the feeds upon mixing. Although the reaction is highly fuel-rich, carbon deposition can be avoided by proper control of the first two sections. The relatively high conversion of light hydrocarbon feed in the first step results in a feed to the second step having essentially no higher hydrocarbons and a low concentration of methane. The low concentration of un-reacted light hydrocarbons in the feed to the third step avoids production of cracking products (coke), in spite of the relatively low levels of steam employed.

The size of the mixing device 300 is about one cubic foot of void space for each 40,000 to 100,000 btu/hr of heat released in the combustion step. The velocity of air in the mixing device 300 is about 50 to about 500 ft/sec, more preferably about 100 to about 400 ft/sec. The pressure of the mixing device 300 is slightly lower than that of the first reaction section 200. The partial pressure of methane in the effluent from the first reaction section 200 is from about 1 to about 7 psia, more preferably about 1 to about 4 psia.

The bulk product fluid 302 from the second mixing device 300 is then passed over the catalyst of the second reaction section 400. On the catalyst surface, carbon dioxide reforms residual methane and hydrogen to for CO as the preferred product and water. Some steam reforming of methane and shift conversion of CO also occur. The composition of the product stream can be readily predicted by chemical equilibrium. The effluent 401 from the second reaction section 400 can then be cooled for further processing to useful products.

In each of reaction sections 200 and 400, any of a number of known reforming catalysts useful in ATR may be utilized, including, for example, nickel supported on an inert material, such as alumina. In the second reaction section 400, the products of the mixing device 300 are passed over a catalyst on which steam and CO₂ reforming reactions complete the conversion of the light hydrocarbon feed. In addition, shift conversion of CO occurs. However, since the amount of steam employed in the first step is low, the extent of shift conversion is small. The final synthesis gas product exiting the fourth step contains CO and H₂ in a ratio optimum for Fischer-Tropsch synthesis. Light hydrocarbon conversion is high. Non-selective carbon dioxide production is low and readily predictable from Gibbs Free Energy considerations.

In the preferred embodiment, the catalyst employed in the second reaction section 400 is the same as that used in the first reaction section 200. The quantity of catalyst in the second reaction section 400 employed is approximately one five thousandth to one fifteen thousandth of the standard hourly flow of gaseous effluent from the reactor. The pressure of the second reaction section 400 is slightly lower than that of the combustion step. The process is adiabatic and the temperature is determined solely by the temperatures and relative quantities of the feeds.

In one embodiment of the invention, the process is used to prepare synthesis gas suitable for Fischer-Tropsch synthesis by reaction of natural gas containing primarily methane with air in the presence of steam. It is known in the art that the rate of non-catalytic oxidation of methane and other light hydrocarbons takes place at much higher rates in relatively pure oxygen than in air. The relative difference in rates contributes to the efficacy of the invention. For example, U.S. Pat. No. 6,447,745 discloses that the first mixing step utilizing oxygen requires a mixing time of less than ten milliseconds. This is in contrast with the successful mixing of air with natural gas involving mixing times of several hundred milliseconds. The relatively slow rate of non-catalytic oxidation in the embodiment using air greatly simplifies the design of the first mixing section 100 and the localized temperature rise in the second mixing section 300.

In an alternate embodiment, feed preheater furnaces upstream of the mixing section 100 are employed. The feed preheater furnaces may be constructed of carbon and/or low alloy steel. The feed preheater furnaces raise the temperature of the light hydrocarbon gases 101 to the desired feed temperature, no less than 750° F., and preferably about 950° F., forming the background fluid 103.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

1. A process for converting light hydrocarbons to synthesis gas, comprising the steps of:
a. thoroughly mixing a light hydrocarbon stream with a first oxidizing gas and steam to form a first homogeneous gaseous mixture;
b. subjecting the first mixture to simultaneous partial oxidation and steam reforming reactions in a first reaction zone in the presence of a first catalyst having partial oxidation and steam reforming activity in order to consume substantially all of the oxygen to produce a gaseous first reaction product comprising unconverted alkanes, hydrogen, and carbon monoxide;
c. thoroughly mixing the gaseous first reaction product with a second oxidizing gas to partially oxidize the unconverted alkanes to form a second homogeneous gaseous mixture; and
d. subjecting the second mixture in a second reaction zone in the presence of a second catalyst having steam reforming activity to convert said unconverted alkanes to carbon monoxide and hydrogen to produce a gaseous second reaction product comprising carbon monoxide and hydrogen having a hydrogen to carbon monoxide ratio of about 2:1,
wherein the quantity of oxygen in the first oxidizing gas in first reaction zone is in the range of from about 30 to about 68 vol % of the lower alkane feed and the quantity of oxygen in the second oxidizing gas in the second reaction zone is in the range of from about 5 to about 25 vol % of the total of the first and second oxidizing gases.

2. The process of claim 1 wherein the quantity of oxygen in the first reaction zone is in the range of from about 45 to about 55 vol % of the lower alkane feed.

3. The process of claim 1 wherein the oxidizing gas is air.

4. The process of claim 1 wherein the oxidizing gas is oxygen.

5. The process of claim 1 wherein the oxidizing gas is enriched air.

6. The process of claim 1 wherein the quantity of steam in the first reaction zone is in the range of from about 2 to about 160 vol % of the lower alkane feed.

7. The process of claim 6 wherein the quantity of steam in the first reaction zone is in the range of from about 22 to about 26 vol % of the lower alkane feed.

8. The process of claim 1, wherein mixing the first homogeneous gaseous mixture occurs for less than 7 seconds.

9. The process of claim 1 wherein at least about 50% of said alkanes are converted in said reaction step (b).

10. The process of claim 1 wherein the pressure of the process ranges from 0 to 300 psig.

11. The process of claim 10 wherein the pressure of the process ranges from 100 to 200 psig.

12. The process of claim 1 wherein the temperature of the process ranges from 400° F. to about 1050° F.

13. The process of claim 12 wherein the temperature of the process ranges from 750° F. to about 900° F.
